(19) United States
(12) Patent Application Publication
(10) Pub. No.: US 2005/0224739 A1
(43) Pub. Date: Oct. 13, 2005

(54) Rear feed micro-fluidic two-way isolation valve

(75) Inventor: Walter J. Kish JR., Las Vegas, NV (US)

Correspondence Address: Kenneth L. Sherman;Myers Dawes Andras & Sherman, LLP, Ste. 1150, 19900 MacArthur Blvd., Irvine, CA, 92612, US

(73) Assignee: Kloehn Company, Ltd., Las Vegas, NV (US)

(21) Appl. No.: 11/099,047

(22) Filed: Apr. 5, 2005

Related U.S. Application Data
(60) Provisional application No. 60/561,777, filed on Apr. 12, 2004.

(51) Int. Cl. F16K 31/02

(52) U.S. Cl. 251/129.17

(57) ABSTRACT

A rear feed solenoid-operated valve design is particularly suited for micro-fluidic applications. The solenoid valve contains various structures and features that provide for small dispense volumes, small internal volume, and fast operating speed. The valve includes an inlet, outlet, coil housing, magnetic plunger rod and a diaphragm assembly. In a preferred embodiment, the diaphragm assembly ensures zero leakage. The solenoid-operated valve further has features allowing for low power consumption. The valve is placed at a desired location by a positioning mechanism located at the rear end of the valve. The positioning mechanism feeds fluid through the inlet and dispenses the fluid at the outlet located at the front, or bottom of the valve.

PRIORITY CLAIM

This application relates to U.S. Provisional Patent Application Ser. No. 60/561,777 filed on Apr. 12, 2004 which is incorporated herein by reference and to which priority is claimed pursuant to 35 USC §119.

### BACKGROUND OF THE INVENTION

1. Field of the Invention

The present invention pertains generally to valves for physical transport and isolation of liquids and gases. More particularly, the present invention pertains to fluidic dispense valves that are designed for low power and quick dispensing applications.

2. Description of the Prior Art and Related Information

Solenoid-operated valves for isolation and transport of fluids are well known. An attractive characteristic of all solenoid-operated valves is that they can be remotely operated because electrical power is used to actuate the valve. Also, a solenoid valve is an attractive option when fluid systems require a valve to cycle open and closed, and thereby pass a set dispense volume of fluid. This is because solenoid valves use a generated and collapsing electromagnetic field to engage a valve stem or a plunger rod. Thus, a power supply can be easily cycled on and off to pass a particular amount of fluid.

Advancements in micro-fluidic arts such as blood chemistry analysis, drug discovery, DNA sequencing, liquid chromatography and other technical arts requiring precision fluid handling have created a need for progress in the components that control and dispense the fluids. Thus, a need exists for a design and method for making and using a solenoid valve that provides for small dispense volumes in close proximity with small fluidic components that can be coupled to a positioning mechanism at the inlet end. In addition, the nature of most micro-fluidic applications places importance on conserving a fluid sample. Therefore, a valve design that allows many valves to be utilized in close proximity resulting in a smaller fluidic platform is desired. Similarly, an isolation valve should be designed for zero leakage.

### BRIEF SUMMARY OF THE INVENTION

The present invention, in a preferred embodiment, is particularly but not exclusively, useful as a rear feed micro-mini solenoid-operated valve for positioning mechanisms and has the ability to control and adjust the flow amount, dispense volume and dispense speed. The novel design of the valve provides a quick operating time and full flow with relatively short movement of the plunger rod. This allows for reduced power consumption by the valve and reduces unnecessary use. In one aspect, a solenoid-operated valve comprises external elements that include a coil housing that defines an axis therethrough and an end cap having a sealing apex on a first side and coupled to a needle on a second side.

The internal elements include a fluid inlet, a fluid outlet and a solenoid coil disposed about the axis and configured to fit inside of the coil housing. Also included within the coil housing is a diaphragm assembly is coupled to a magnetic plunger rod at a proximal end thereof. The solenoid coil generates a magnetic field when energized. The magnetic field causes the plunger rod to traverse axially inside of the coil housing. In an open cycle, the plunger rod moves axially to unseat the valve. In a closed cycle, the plunger rod moves in a reverse axial direction to seat the valve.

Unlike conventional valves, the coil housing design allows the diaphragm to be pressed into the end cap and form a fluid tight seal with the housing in one simple, time saving assembly procedure. Conventional designs use screws to attach the end cap to the housing which can take up to 20 seconds to screw in. Pressing the end cap into the housing, however, takes approximately 2-3 seconds. This is an important money saving feature when multiplied over by the production of thousands of valves.

The diaphragm assembly is coupled to the plunger rod using an insert molding process and forms a fluid tight seal against the raised sealing apex when the solenoid-operated valve is in the normally closed position. In a preferred embodiment, the fluid inlet is adapted to be coupled to a positioning mechanism at a top end of the valve. This is a preferable design feature due to the ultimate use of the valve. The valves are ultimately used with XYZ machines that dispense into cuvettes from a top end. Cuvettes are essentially miniature cups or cavities in a plate. The dispense tips of the XYZ machines fit right into the cuvettes and dispense fluid therein. Having an XYZ machine come from the bottom of the cuvettes would be inefficient because of the wiring of the XYZ machine.

In a second embodiment, the diaphragm assembly comprises a diaphragm sleeve that couples to the diaphragm on one side and to a tip of the plunger rod on the other side.

The valve further comprises a valve seat about the axis and around an inner diameter of the end cap. When the valve is in the closed position the diaphragm assembly engages with the valve seat and the raised sealing apex and forms a fluid tight seal.

The internal volume is approximately equal to 17 μl in a preferred embodiment. The inlet has a diameter of approximately 0.020 inches in a preferred embodiment.

The valve further comprises a bobbin disposed about the axis of the coil housing. The bobbin fits inside of the coil housing and defines an inner hollow section. The bobbin and the coil housing together define an outer hollow section. A solenoid coil is wrapped around the bobbin within the outer hollow section. The valve further comprises a diaphragm assembly coupled to the plunger rod at a proximal end thereof. A spring having a spring force fits in between a protruding rib of the diaphragm assembly and around a circumference of the plunger rod.

In an open cycle, the solenoid coil is energized and creates a magnetic field. The magnetic field forces the plunger rod to traverse axially against the spring force and move the diaphragm assembly in a direction away from the outlet, allowing fluid to pass. In a closed cycle, the solenoid coil is de-energized and releases the magnetic field. This allows the spring force to move the diaphragm assembly in a reverse direction sealing the inlet and the outlet.

The valve further comprises a mag pin configured to fit inside of the bobbin, in the inner hollow section and adjacent to the plunger rod. When the solenoid-operated valve is in the closed position the mag pin and plunger rod together define an air gap with a magnitude designed for optimum performance. In a preferred embodiment, the air gap is approximately equal to 0.005 inches. The mag pin is adjustable to control the flow amount, dispense volume, and dispense speed. The mag pin may have threads, which have a pitch length of approximately 0.025 inches. The adjustability of the air gap is crucial for the accuracy of the valve. Without an adjustable air gap there is no way to set the flow of the tolerances. The present invention dispenses at an accuracy of approximately 2-3% from each other and the increase of the gap increases the dispense speed by approximately 10%.

The valve may further comprise a mag disc configured to fit around the mag pin at an end thereof. The mag disc configuration is selected for optimum strength of the magnetic field and optimum performance of the valve. The valve further comprises one or more electrical leads mechanically coupled to the bobbin and electrically coupled to the solenoid coil.

In a preferred embodiment, the dead volume, or fluid internal to the valve that is not flushed out during a purge cycle, is approximately equal to zero. This avoids the problem of carryover. The valve is designed for zero leakage past the diaphragm assembly. Thus, the solenoid-operated valve may preferably comprise an isolation valve.

In a preferred embodiment the coil housing is rectangular in shape and has sides that are approximately 0.250 inches wide. This miniature size is unique and desirable for isolation valves because modernly smaller samples are being used. The small size allows for a smaller internal volume and therefore is easier to flush out. The valves can provide more accurate sample dispenses because there is less fluid inside the valve and the smaller valve is easier to turn on and off. The size of the valve also allows more valves attach to the same platform. This is crucial for upcoming platform technology that allows the platforms to be transported.

The valve may have a dispense speed designed to be approximately 10 milli-sec in a preferred embodiment. The end cap may be composed of a chemically inert polymer, such as PEEK (Poly Ether Ether Ketone), while the plunger rod and the coil housing may be composed of 400-series stainless steel. Unlike conventional rear feed valves, the valve is designed for low power consumption approximately equal to one (1) Waft.

The valve may further comprise a seal adjacent to the end cap for providing a fluid tight seal to a valve manifold. The seal has one or more built-in O-rings and may be composed of EPDM (Ethylene Propylene Diene Monomer) rubber material.

A method of making a solenoid-operated valve is also provided. The method includes the steps of providing a coil housing defining an axis, disposing a solenoid actuated plunger rod within the coil housing and allowing for axial movement of the plunger rod. The method also includes providing an air gap adjacent to the solenoid actuated plunger rod, and setting the dispense volume of the pump by precisely setting the size of the air gap. The method further comprises providing a spring having a spring force configured axially with the plunger rod to assist axial movement of the plunger rod.

In a preferred embodiment, the method further comprises energizing the solenoid to induce a magnetic field along the axis, the spring force and the magnetic field configured to provide axial movement of the plunger rod when the magnetic field is alternated on and off.

The invention provides a solenoid-operated valve design and method particularly for small manufacture. The valve design allows for small dispense volumes, a small internal volume, and fast operating speed and is particularly suited for a compact, high-density valve manifold. Unlike conventional rear feed valves, the valve is designed for low power consumption and is easy to manufacture, simple to use, and cost effective.

The term fluid used herein, means any substance that can flow, liquid or gas.

These, as well as other advantages of the present invention, will become more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an exploded side view of a preferred embodiment of a solenoid-operated valve according to the present invention;

FIG. 2 is an exploded isometric view of a preferred embodiment of a solenoid-operated valve according to the present invention;

FIG. 3 is an axial cross-sectional view of the preferred embodiment of a solenoid-operated valve in the closed position according to the present invention;

FIG. 4 is an axial cross-sectional view of the preferred embodiment of a solenoid-operated valve in the open position according to the present invention;

FIG. 5 is an exploded isometric view of the diaphragm assembly of a second preferred embodiment according to the present invention; and

FIG. 6 is an exploded isometric view of the second preferred embodiment of a solenoid-operated valve according to the present invention.

### DETAILED DESCRIPTION OF THE PREFERRED EMBODIMENTS

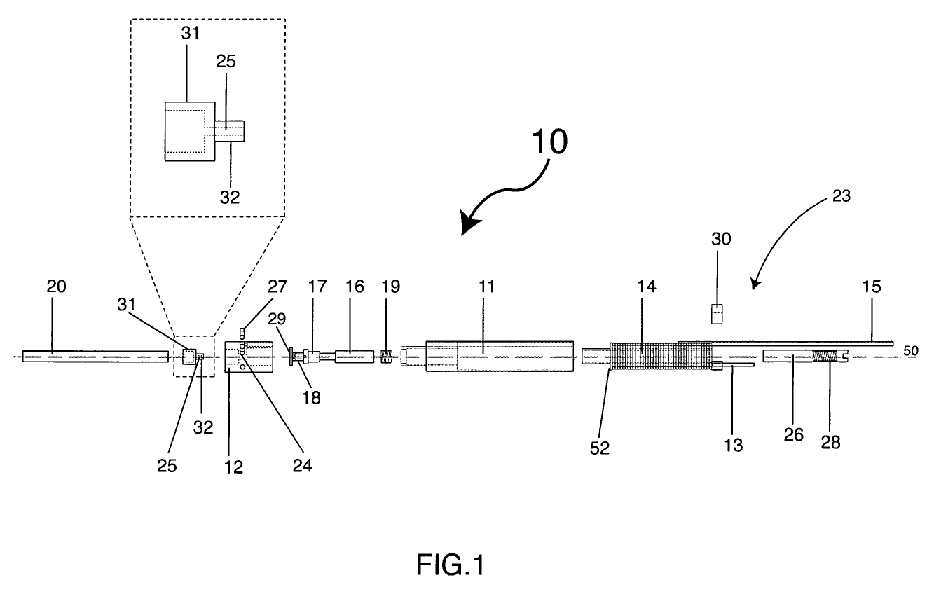

Referring initially to FIG. 1, a first preferred embodiment of a solenoid-operated valve 10 according to the present invention is shown. The valve 10 is a two-way isolation valve in that the valve 10 has two positions: open and closed. In this example, the valve 10 is de-energized in the closed position. The valve 10 comprises external components including a coil housing 11 and an end cap 12. A top or rear end 23 of the solenoid valve 10 includes electrical leads 13 that provide power to energize a solenoid coil 14. The valve 10 includes an inlet 15 at the rear end 23 of the valve 10 and an outlet 20 on the bottom, in order to conveniently couple the valve 10 to a positioning mechanism, such as an XYZ machine (not shown). In a preferred embodiment, the valve 10 is an isolated valve that is fed through the top or rear end 23.

Unlike conventional valves, the housing 11 is square with four 0.250 inch sides, allowing many valves to be utilized in close proximity so as to provide a smaller fluidic platform. The smaller size is unique and desirable for isolation valves because smaller samples are being requested as different technologies advance. The small size allows for a smaller internal volume and therefore is easier to flush out. The valves can provide more accurate sample dispenses because there is less fluid inside the valve and the smaller valve is easier to turn on and off.

A plunger rod 16 is configured to reciprocate axially inside of the coil housing 11 when the valve 10 is cycled open and closed. Further, a diaphragm assembly 17 is located on an end of the plunger rod 16, and seats the inlet and outlet ports 24, 25 inside of the end cap 12. In the preferred embodiment, the diaphragm assembly 17 comprises a diaphragm 29 adapted to be coupled to the plunger rod 16.

The diaphragm 29 includes a rib 18 protruding around a circumference thereof. The rib 18 assures the seal between the plunger rod 16 and the inlet and outlet ports 24, 25. Further, a spring 19 is located between the rib 18 and an end of a spool 52. The solenoid coil 14 is wrapped around the spool 52 as shown. When the coil 14 is deactivated, the spring 19 provides a bias that forces the plunger rod 16 to close the outlet port 25 of the valve 10. The outlet 20 is coupled to the housing 11 by a stem 31 that is in fluid communication with the outlet port 25 via a stem insert 32. The stem insert 32 provides a tight connection between the end cap 12 and the outlet 20.

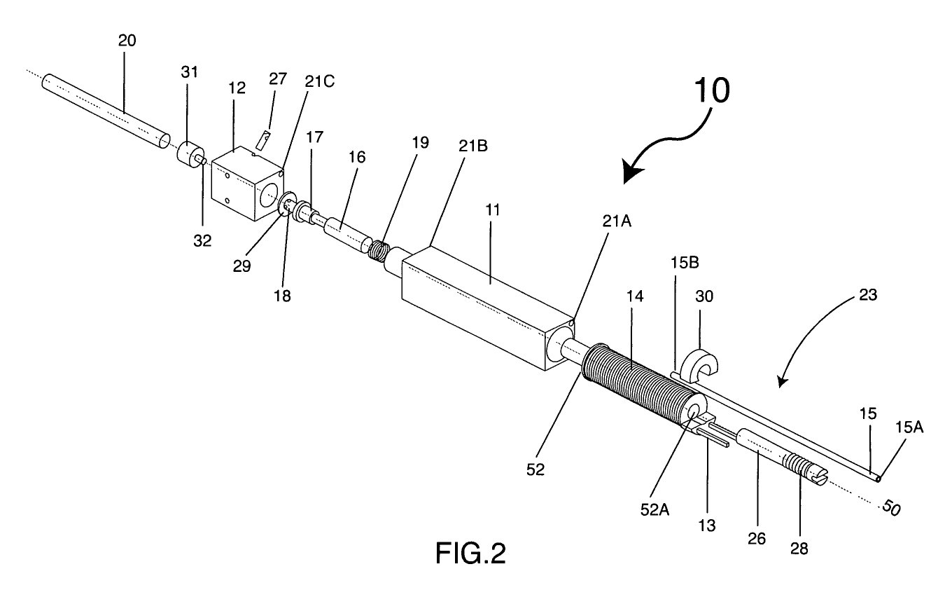

FIG. 2 is, an exploded isometric view of individual components of the valve 10, disposed about center axis 50. FIG. 2 shows a rear end view of the valve 10, wherein a head portion of a mag pin 26 is illustrated. The adjustability of the air gap is crucial for the accuracy of the valve. Without an adjustable air gap there is no way to set the flow of the tolerances. The present invention dispenses at an accuracy of approximately 2-3% from each other and the increase of the gap increases the dispense speed by approximately 10%.

A mag disc 30 lies adjacent to the solenoid coil 14. When the coil is energized, the mag disc 30 shapes a magnetic flux field generated by the solenoid coil 14. The spool 52 defines an inner hollow section 52A that allows the plunger rod 16 to reciprocate axially.

A first end 15A of the inlet 15 attaches to a positioning mechanism (not shown) while the valve 10 hangs there from. Having the inlet 15 located at a tope end of the valve 10 allows the positioning mechanism to feed into cuvettes or cavities for dispensing the fluid into. When assembled, a second end 15B of the inlet 15 is inserted into a first aperture 21A of the housing 11 and extends through a second aperture 21B of the housing 11. The second aperture 21B of the housing is aligned with a third aperture 21C on the end cap 12. The end cap 12 further includes a plug 27 that the second end 15B of the inlet 15 feeds into. The plug 27 leads to the inlet port 24 (shown in FIGS. 1 and 4) within the end cap 12. Additionally, the end cap 12 presses against the coil housing 11, forming a fluid tight junction in between.

Unlike conventional valves, the coil housing design allows the diaphragm to be pressed into the end cap and form a fluid tight seal with the housing in one simple, time saving assembly procedure. Conventional designs use screws to attach the end cap to the housing, which can take up to 20 seconds to screw in. However, pressing the end cap into the housing takes approximately 2-3 seconds. This is an important money saving feature when multiplied over by the production of thousands of valves.

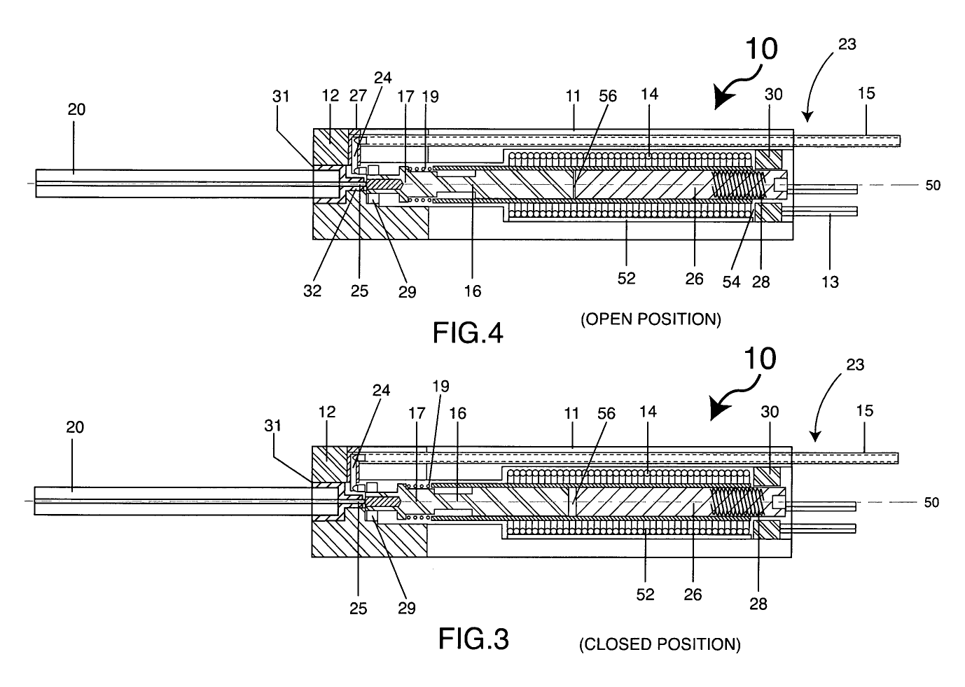

As is best seen in FIG. 3, the coil housing 11 and the spool 52 together define an outer hollow section 54 that provides an area for the solenoid coil 14 to be wrapped around the spool 52. Preferably, the coil 14 is wrapped with coating or tape to prevent shorting. As an example, when operated, the spring 19 exerts a linear spring force on the diaphragm 29 and seals the diaphragm 29 against the end cap 12. The spring force moves the plunger rod 16 axially to shut the valve 10 when the solenoid coil 14 is de-energized. An air gap 56 determines how far the plunger rod 16 travels during a dispense cycle open and closed operation.

Unlike conventional valves, the mag pin 26 can be operated by a user to adjust the magnitude of the air gap 56. In a preferred embodiment, the mag pin 26 further includes threads 28 to adjust the magnitude of the air gap 56. The air gap 56 controls the flow amount, dispense volume and dispense speed. As those skilled in the art will recognize, a similar design embodied by the present invention can be a valve that is normally open.

As shown in FIG. 4, when the solenoid coil 14 is activated a DC voltage pulse energizes the coil 14 and actuates valve 10. The coil 14 generates a magnetic flux field that causes the plunger rod 16 and the diaphragm 29 to move against the force of the spring 19 proximate the air gap 56 until the plunger rod 16 contacts the mag pin 26 which is in a fixed position. At this point, the diaphragm 29 pulls away from the sealing apex of the end cap 12 whereby the liquid or gas media flows through the inlet port 24 and out of the outlet port 25. In this manner, the valve 10 provides quick operation such that the diaphragm assembly 17 need not travel a great distance to provide full flow past the valve 10.

In a preferred embodiment, the mag screw 26, the plunger rod 16, the coil housing 11, and the mag disc 30 are made from 400-series stainless steel chosen for its magnetic properties and its ability to resist corrosion. The end cap 12 has channels that form the inlet and outlet ports 24, 25, is preferably composed of a chemically inert material, such as PEEK (Poly Ether Ether Ketone). Significantly, the valve 10 is designed for zero “dead volume” which conserves samples such as in medical applications, and provides ease of cleaning and flushing. It is also important to note that valve 10 can be specifically employed in micro-fluidic applications. In a preferred embodiment, the valve 10 has a dispense volume of approximately five (5) nano-liters or less for one open/closed cycle, and an end cap 12 internal volume of approximately 17 micro-liters.

Preferably, the magnitude of the air gap 56 is, for example, approximately 0.005 thousandths of an inch and a diameter of the inlet port 24 is, for example, approximately 0.020 thousandths of an inch. Further, the magnitude of the air gap 56 is selected to be, for example, approximately one-quarter (%) the design diameter of the inlet port 24. Such dimensions, unlike conventional valves, provide quick operating time and full flow with relatively short movement of the plunger rod 16, reduce power consumption by the valve 10 and reduce unnecessary use of the solenoid coil 14 which can be relatively weak (e.g., one (1) Watt). Such a coil 14 is also beneficial in minimizing the effects of residual magnetism that affect the dispense speed of valve 10. In a preferred embodiment, the valve 10 has a dispense speed of approximately 10 milli-seconds.

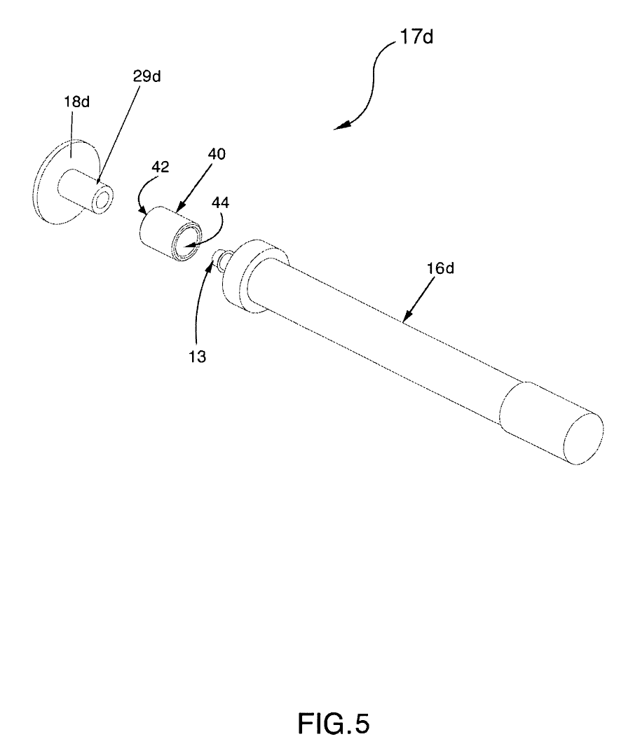

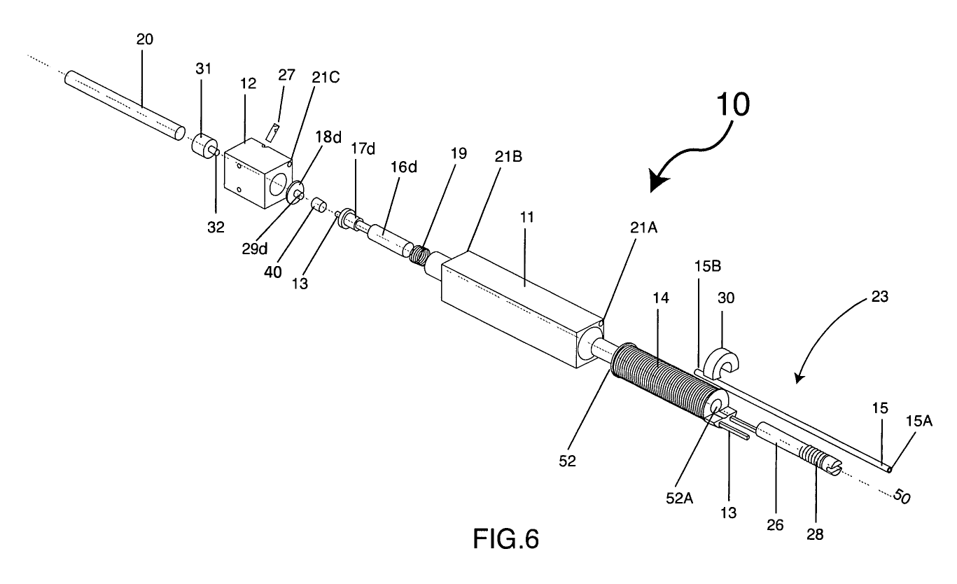

In a second embodiment illustrated in FIGS. 5 and 6, elements of similar structure are designated by the same reference numerals followed by the lower case “d”. In the second preferred embodiment, the diaphragm assembly 17d includes a diaphragm 29d, a diaphragm sleeve 40 and a plunger rod 16d. The diaphragm sleeve 40 couples the diaphragm 29d to the plunger rod 16d via a first and second peripheral opening 42, 44 located on the sleeve 40. During de-actuation, the diaphragm 29d fills the first peripheral opening 42. Once actuated, a tip 13 of the plunger rod 16d seats into the second opening 44 of the sleeve 40, thereby filling the second opening 44 and sealing the apex.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Rear Feed Micro-fluidic Two-Way Isolation Valve as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

1. A valve, comprising:
a fluid inlet adapted to be coupled to a positioning mechanism at a top end of the valve;
a fluid outlet at a bottom end of the valve;
a coil housing having four sides, each side being approximately 0.250 inches, the coil housing defining an axis;
a magnetic plunger rod configured to traverse axially inside of the coil housing;
a diaphragm assembly coupled to the plunger rod at an end thereof; and
an end cap having a raised sealing apex and a side that presses against the coil housing so as to form a fluid tight seal.

2. The valve of claim 1, wherein:
the end cap further includes channels that form a fluid inlet port and a fluid outlet port and an internal volume of the solenoid-operated valve, and
the diaphragm assembly forms a fluid tight seal against the raised sealing apex when the solenoid-operated valve is in the closed position.

3. The valve of claim 2, further comprising a valve seat about the axis and around an inner diameter of the end cap such that when the valve is in a closed position the diaphragm assembly engages with the valve seat.

4. The valve of claim 1, wherein the diaphragm assembly is coupled to the plunger rod using an insert molding process.

5. The valve of claim 1, wherein the inlet has a diameter of approximately 0.020 inches.

6. The valve of claim 1, further comprising:
a bobbin disposed about the axis of the coil housing and defining an inner hollow section, the bobbin configured to fit inside of the coil housing;
a solenoid coil wrapped around the bobbin within an outer hollow section; and
a spring having a spring force configured to fit in between an end of the bobbin and a rib protruding around a circumference of the plunger rod;
wherein the solenoid coil is energized on an open cycle creating a magnetic field, the magnetic field forces the plunger rod to traverse axially against the spring force and move the diaphragm assembly in a direction away from the outlet port so as to allow fluid to pass; and
wherein the solenoid coil is de-energized in a closed cycle releasing the magnetic field allowing the spring force so as to move the diaphragm assembly towards the inlet and the outlet.

7. The valve of claim 6, further comprising a mag pin configured to fit inside of the bobbin in the inner hollow section and adjacent to the plunger rod,
wherein the mag pin and the plunger rod together define an adjustable air gap when the solenoid-operated valve is in the closed position.

8. The valve of claim 7, wherein the air gap, when fully extended, is approximately equal to 0.005 inches.

9. The valve of claim 7, wherein the mag pin is adjustable, so as to control the flow amount, dispense volume, and dispense speed.

10. The valve of claim 7, wherein the mag pin is threaded.

11. The valve of claim 6, further comprising one or more electrical leads mechanically coupled to the bobbin and electrically coupled to the solenoid coil.

12. The valve of claim 1, wherein the valve is designed for zero leakage past the diaphragm assembly.

13. The valve of claim 1, wherein during a dispense cycle, approximately (five) 5 nano-liters of fluid is passed by the valve.

14. The valve of claim 1, wherein the valve has a dispense speed designed to be approximately ten (10) milli-secs.

15. The valve of claim 1, wherein the valve is designed for low power consumption approximately equal to one (1) Waft.

16. The valve of claim 1, wherein the solenoid-operated valve is an isolation valve.

17. The valve of claim 1, wherein the valve is an isolated valve with back feed.

18. The valve of claim 1, wherein the end cap is coupled to the housing without the use of screws.

19. A solenoid-operated valve, comprising:
a fluid inlet at a top end of the valve;
a fluid outlet at a bottom end of the valve that releases fluid during a dispense cycle;
a coil housing defining an axis;
a solenoid coil disposed about the axis and configured to fit inside of the coil housing, the solenoid coil generating a magnetic field when energized;
a magnetic plunger rod configured to traverse axially inside of the coil housing, and
a mag pin, the mag pin and the plunger rod defining an adjustable air gap;
wherein in an open cycle the plunger rod moves axially to unseat the valve and in a closed cycle the plunger rod moves in a reverse axial direction to seat the valve.

20. The solenoid-operated valve of claim 19, further comprising:
an end cap having a raised sealing apex and a side that presses against the coil housing during assembly so as to form a fluid tight seal;
wherein the end cap has channels forming a inlet port and an outlet port and further forms an internal volume of the solenoid-operated valve.

21. The solenoid-operated valve of claim 20, further comprising:
a diaphragm assembly coupled to the plunger rod at an end thereof;
wherein the diaphragm assembly forms a fluid tight seal against the raised sealing apex when the solenoid-operated valve is in the closed position.

22. The solenoid-operated valve of claim 20, further comprising a valve seat about the axis and around an inner diameter of the end cap,
wherein during a closed cycle the diaphragm assembly seals the valve seat.

23. The solenoid-operated valve of claim 19, wherein the fluid inlet has a diameter of approximately 0.020 inches.

24. The solenoid-operated valve of claim 19, further comprising:
a bobbin defining an inner hollow section and configured to fit inside of the coil housing, the bobbin and coil housing together defining an outer hollow section;
a solenoid coil wrapped around the bobbin at the outer hollow section; and
a spring having a spring force configured to fit in between an end of the bobbin and a rib protruding around a circumference of the plunger rod;
wherein in an open cycle the solenoid coil is energized creating a magnetic field, so as to force the plunger rod to traverse axially against the spring force and move the diaphragm assembly in a direction away from the inlet and the outlet.

25. The solenoid-operated valve of claim 24, wherein the mag pin is configured to fit inside of the bobbin adjacent to the plunger rod in the inner hollow section.

26. The solenoid-operated valve of claim 19, wherein the air gap is approximately equal to 0.005 inches.

27. The solenoid-operated valve of claim 19, wherein the mag pin is threaded to adjust the position.

28. The solenoid-operated valve of claim 19, further comprising a mag disc coupled to the mag pin at an end thereof.

29. The solenoid-operated valve of claim 24, further comprising one or more electrical leads mechanically coupled to the bobbin and electrically coupled to the solenoid coil.

30. The solenoid-operated valve of claim 19, wherein the valve is designed for zero leakage past the diaphragm assembly and wherein the solenoid-operated valve is an isolation valve.

31. The solenoid-operated valve of claim 19, wherein during a dispense cycle not more than approximately five (5) nano-liters of fluid is passed.

32. The solenoid-operated valve of claim 19, wherein the coil housing has sides that are approximately 0.250 inches wide.

33. The solenoid-operated valve of claim 19, wherein the valve has a dispense speed designed to be approximately ten (10) milli-secs.

34. A method of making a solenoid-operated valve, the method comprising:
providing a coil housing defining an axis;
disposing a solenoid actuated plunger rod within the coil housing allowing for axial movement of the plunger rod;
providing an air gap adjacent to the solenoid actuated plunger rod;
providing an inlet on a top end of the housing that is adapted to be coupled to a positioning mechanism and an outlet on a bottom end of the housing; and
adjusting the size of the air gap so as to set the dispense volume of the pump.

35. The method of making a solenoid-operated valve of claim 34, further comprising providing a spring having a spring force configured axially with the plunger rod.

36. The method of making a solenoid-operated valve of claim 34, further comprising energizing the solenoid to induce a magnetic field along the axis, the spring force and the magnetic field being configured to provide axial movement of the plunger rod when the magnetic field is alternated on and off.

37. The method of making a solenoid-operated valve of claim 34, further comprising:
providing an end cap having a side;
pressing the side of the end cap against the coil housing during assembly; and
forming a fluid tight seal.
